(19) United States
(12) Patent Application Publication
(10) Pub. No.: US 2015/0138065 A1
(43) Pub. Date: May 21, 2015

(54) HEAD-MOUNTED INTEGRATED INTERFACE

(71) Applicant: NVIDIA CORPORATION, Santa Clara, CA (US)

(72) Inventor: Robert Alfieri, Chapel Hill, NC (US)

(73) Assignee: NVIDIA CORPORATION, Santa Clara, CA (US)

(21) Appl. No.: 14/086,109

(22) Filed: Nov. 21, 2013

(51) Int. Cl. G06F 3/01; G02B 27/01

(52) U.S. Cl. CPC G06F 3/017; G02B 27/017; G02B 2027/0178
USPC 345/156

(57) ABSTRACT

A head mounted integrated interface (HMII) is presented that may include a wearable head-mounted display unit supporting two compact high resolution screens for outputting a right eye and left eye image in support of the stereoscopic viewing, wireless communication circuits, three-dimensional positioning and motion sensors, and a processing system which is capable of independent software processing and/or processing streamed output from a remote server. The HMII may also include a graphics processing unit capable of also functioning as a general parallel processing system and cameras positioned to track hand gestures. The HMII may function as an independent computing system or as an interface to remote computer systems, external GPU clusters, or subscription computational services, The HMII is also capable linking and streaming to a remote display such as a large screen monitor.

### BACKGROUND OF THE INVENTION

1. Field of the Invention

Embodiments of the present invention generally relate to computer interfaces and, more specifically, to a head-mounted integrated interface.

2. Description of the Related Art

The computer interface has not changed significantly since the Apple Macintosh was introduced in 1984. Most computers support some incarnation of an alphanumeric keyboard, a pointer such as a mouse, and a 2D display or monitor. Typically, computers support some form of a user interface that combines the keyboard and mouse input and provides visual feedback to the user via the display. Virtual reality (VR) technology introduced new methods for interfacing with computer systems. For example, VR displays that are head-mounted present separate left and right eye images in order to generate stereoscopic 3-dimensional (3D) displays, include input pointer devices tracked in 3D space, and output synchronized audio to the user to provide a richer feeling of immersion in the scene being displayed.

User input devices for the VR system include data gloves, joysticks, belt mounted keypads, and hand-held wands. VR systems allow users to interact with environments ranging from a completely virtual environment generated entirely by a computer system to an augmented reality environment in which computer generated graphics are superimposed onto images of a real environment. Representative examples range from virtual environments such as molecular modeling and video games to augmented reality applications such as remote robotic operations and surgical systems.

One drawback in current head-mounted systems is that in order to provide high resolution input and display, the head-mounted interface systems are tethered via communication cables to high performance computer and graphic systems. The cables not only restrict the wearer's movements, the cables also impair the portability of the unit. Other drawbacks of head-mounted displays are bulkiness and long processing delays between tracker information input and visual display update which is commonly referred to as tracking latency. Extended use of current head-mounted systems can adversely affect the user causing physical pain and discomfort.

As the foregoing illustrates, what is needed in the art is a more versatile and user-friendly head-mounted display system.

### SUMMARY OF THE INVENTION

One embodiment of the present invention is, generally, an apparatus configured to be wearable by a user and includes at least one display in front of the user's eyes on which a computer-generated image is displayed. The apparatus also incorporates at least two cameras with overlapping fields-of view to allow a gesture of the user to be captured. Additionally, a gesture input module is coupled to the cameras and is configured to receive visual data from the cameras and identify the user gesture within the visual data. The identified gesture is then used to affect the computer-generated image presented to the user.

Integrating the cameras and the gesture input module into a wearable apparatus improve the versatility of the device relative to other devices that require separate input devices (e.g., keyboards, mice, joysticks, and the like) to permit the user to interact with the virtual environment displayed by the apparatus. Doing so also improves the portability of the apparatus because, in at least one embodiment, the apparatus can function as a fully operable computer that can be used in a variety of different situations and scenarios where other wearable devices are ill-suited.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram illustrating a head-mounted integrated interface (HMII) configured to implement one or more aspects of the present invention.

FIG. 2 is a block diagram of the functional components included in the HMII of FIG. 1, according to one embodiment of the present invention.

FIG. 3 is a flow diagram of detecting user gestures for changing the virtual environment presented to the user, according to one embodiment of the present invention.

FIG. 4A illustrates one configuration for use of the HMII with local resources, according to one embodiment of the present invention.

FIG. 4B illustrates a configuration for use of the HMII with networked resources, according to one embodiment of the present invention.

FIG. 5 is a is a block diagram illustrating a computer system configured to implement one or more aspects of the present invention.

FIG. 6 is a block diagram of a parallel processing unit (PPU) included in the parallel processing subsystem of FIG. 5, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### Head-Mounted Integrated Interface System Overview

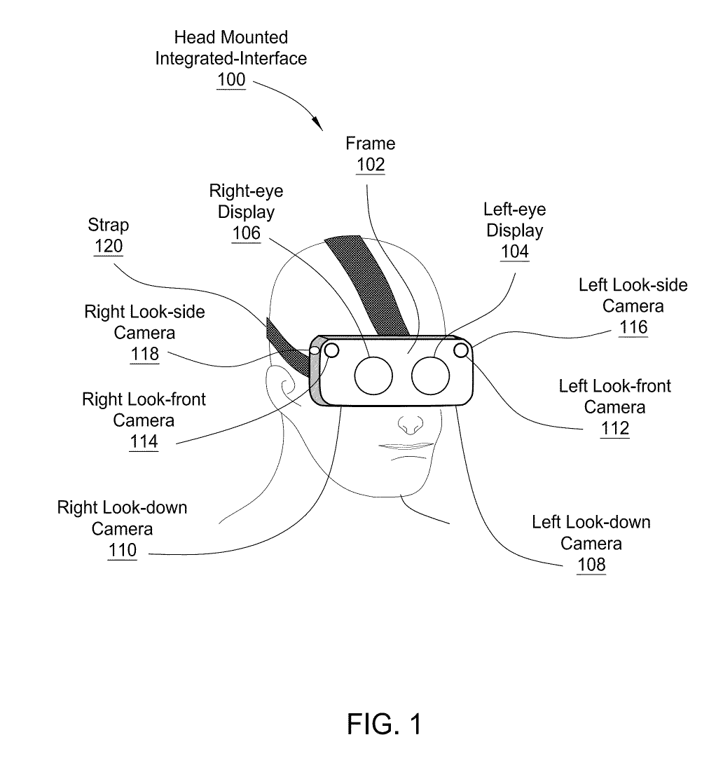

FIG. 1 is a diagram illustrating a head-mounted integrated interface (HMII) 100 configured to implement one or more aspects of the present invention. As shown, HMII 100 includes a frame 102 configured to be wearable on a user's head via some means such as straps 120 as shown. In one embodiment, the frame 102 may contain a processor system which will be described in greater detail below. Frame 102 includes a display that includes a left-eye display 104 positioned to be viewed by the user's left eye and a right-eye display 106 positioned to be viewed by the user's right eye. The displays 104 and 106 are not limited to any specific display technology and may include LCDs, LEDs, projection displays, and the like. Incorporated into frame 102 are additional input devices that include, but are not limited to, a left look-down camera 108, a right look-down camera 110, a right look-front camera 114, a left look-front camera 112, a left look-side camera 116, and a right look-side camera 118.

In one embodiment, gesture input is captured by the cameras (e.g., cameras 108 and 110 and processed by the processor system, or external systems with which the HMII 100 is in communication. Based on the detected gestures, the HMII 100 may update the image presented on the displays 104 and 106 accordingly. To do so, the fields-of-view of at least two of the cameras in the HIID 100 may be at least partially overlapping to define a gesture sensing region. For example, the user may perform a hand gesture that is captured in the overlapping fields-of-views and is used by the HMII 100 to alter the image presented on the displays 104 and 106.

In one embodiment, the left look-down camera 108 and right look-down camera 110 are oriented so that at least a portion of the respective fields-of-view overlap in a downward direction—e.g., from the eyes of the user towards the feet of the user. Overlapping the fields-of-view may provide additional depth information for identifying the user gestures. The left look-front camera 112 and right look-front camera 114 may also be oriented so that at least a portion of their respective fields-of-view overlap. Thus, the visual data captured by cameras 112 and 114 may also be used to detect and identify user gestures. As shown generally in FIG. 1, the various cameras (including side looking cameras 116 and 118) illustrate that different fields-of-view can be established to increase the gesture recognition region for detecting and identifying user gestures. Increasing the size of the gesture recognition region may also aid the HMII 100 to identify gestures made by others who near the user.

The camera 1108, 110, 112, 114, 116, and 118 may also be used to augment the apparent field of view which may be presented in the left- and right-eye displays 104 and 106. Doing so may aid the user to identify obstructions that would otherwise be outside the field of view presented in the displays 104 and 106.

Situating at least two of the input cameras with overlapping fields of view, as for example left look-down camera 108 and right look-down camera 110, enables stereoscopic views of hand motions that in turn permits very fine resolution, distinguishing user movements to sub-millimeter accuracy, and discrimination of movements not just from the visual context surrounding the gestures but also discriminating between gestures that have nearly identical features. Fine movement resolution thereby enables greater accuracy in interpreting the movements and thereby greater accuracy and reliability in translating gestures into command inputs. Some examples include: wielding virtual artifacts in gaming environments such as swords or staffs, coloring information in the environment in an augmented reality application, exchanging virtual tools or devices between multiple users in a shared virtual environment, etc. It should be noted that gestures are not restricted to hands of the user or even to hands generally and that these examples are not exhaustive. Gesture recognition can include other limb movements, object motions, and/or analogous gestures made by other users in a shared environment. Gestures may also include without limitation myelographic signals, electroencephalographic signals, eye tracking, breathing or puffing, hand motions, and so forth, whether from the wearer or another participant in a shared environment.

Another factor in the handling of gestures is the context of the virtual environment being displayed to the user when a particular gesture is made. The simple motion of pointing with an index finger when a word processing application is being executed on the HMII 100 could indicate a particular key to press or word to edit. The same motion in a game environment could indicate that a weapon is to be deployed or a direction of travel.

Gesture recognition offers a number of advantages for shared communication or networked interactivity in applications such as medical training, equipment operation, and remote or tele-operation guidance. Task specific gesture libraries or neural network machine learning could enable tool identification and feedback for a task. One example would be the use of a virtual tool that translates into remote, real actions. For example, manipulating a virtual drill within a virtual scene could translate to the remote operation of a drill on a robotic device deployed to search a collapsed building. Moreover, the gestures may also be customizable. That is, the HMII 100 may include a protocol for enabling a user to add a new gesture to a list of identifiable gestures associated with user actions.

In addition, the various cameras in the HMII 100 may be configurable to detect spectrum frequencies in addition to the visible wavelengths of the spectrum. Multi-spectral imaging capabilities in the input cameras allows position tracking of the user and/or objects by eliminating nonessential image features (e.g., background noise). For example, in augmented reality applications such as surgery, instruments and equipment can be tracked by their infrared reflectivity without the need for additional tracking aids. Moreover, HMII 100 could be employed in situations of low visibility where a “live feed” from the various cameras could be enhanced or augmented through computer analysis and displayed to the user as visual or audio cues.

In one embodiment, the HMII 100 is capable of an independent mode of operation where the HMII 100 does not perform any type of data communication with a remote computing system or need power cables. This is due in part to power unit which enables the HMII 100 to operate independently free from external power systems. In this embodiment, the HMII 100 may be completely cordless without a wired connection to an external computing device or a power supply. In a gaming application, this mode of operation would mean that a player could enjoy a full featured game anywhere without being tethered to an external computer or power unit. Another practical example of fully independent operation of the HMII 100 is a word processing application. In this example, the HMII 100 would present, using the displays 104 and 106, a virtual keyboard, virtual mouse, and documents to the user via a virtual desktop or word processing scene. Using gesture recognition data captured by one or more of the cameras, the user may type on a virtual keyboard or move a virtual mouse using her hand which then alters the document presented on the displays 104 and 105. Advantageously, the user has to carry only the HMII 100 rather than an actual keyboard and/or mouse when moving to a different location. Moreover, the fully contained display system offers the added advantage that documents are safer from prying eyes.

in operation, frame 102 is configured to fit over the user's eyes positioning the left-eye display 104 in front of the user's left eye and the right-eye display 106 in front of the user's right eye. In one embodiment, processing module is configured to fully support compression/decompression of video and audio signals. Also, the left-eye display 104 and right-eye display 106 are configured within frame 102 to provide separate left eye and right eye images in order to create the perception of a three-dimensional view. In one example, left-eye display 104 and right-eye display 106 have sufficient resolution so to provide a high-resolution field of view greater than 90 degrees relative to the user. In one embodiment, left-eye display 104 and right-eye display 106 positions in frame 102 are adjustable to match variations in eye separation between different users.

In another embodiment left-eye display 104 and right-eye display 108 may be configured using organic light-emitting diode or other effective technology to permit “view-through” displays. View-through displays, for example, permit a user to view the surrounding environment, through the display. This creates an effect of overlaying or integrating computer generated visual information into the visual field (referred to herein as “augmented reality”). Applications for augmented reality range from computer assisted operating manuals for complex mechanical systems to surgical training or telemedicine. With view-through display technology, frame 102 would optionally support an opaque shield that would be used to screen out the surrounding environment. One embodiment of the HMII 100 display output in the view-through mode is super-position of graphic information into a live feed of the user's surroundings, The graphic information may change based on the gestures provided by the user. For example, the user may point at different objects in the physical surroundings. In response, the HMII 100 may superimpose supplemental information on the displays 104 and 106 corresponding to the objects pointed to by the user. In one example, the integrated information may be displayed in a “Heads-up Display” (HUD) operation. The HUD mode may then be used in navigating unfamiliar locations, visually highlighting key components in machinery or an integrated chip design, alert the wearer to changing conditions, etc.

Although FIG. 1 illustrates six cameras, this is for illustration purposed only. Indeed, the HMII 100 may include less than six or more than six cameras and still perform the functions described herein.

### Functional Components of the HMII

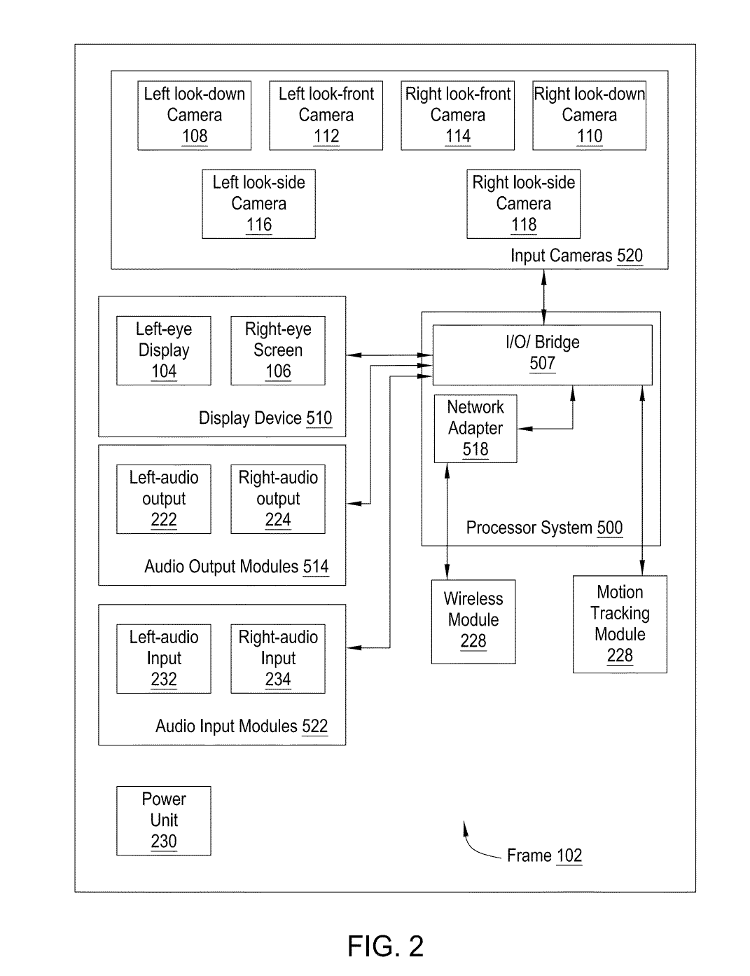

FIG. 2 is a block diagram of the functional components in the HMII 100, according to one embodiment of the present invention. To enhance its portability, the HMII 100 may include a power unit 230 within frame 102. As discussed above, the cameras 520 may provide input to the gesture recognition process as well as visual data regarding the immediate environment. The cameras 520 communicate with the processor system 500 via the I/O bridge 507 as indicated. Specifically, the data captured by the cameras 520 may be transported by the bridge 507 to the processor system 500 for further processing.

The displays 104 and 106 described above are components of the display device 510 in FIG. 2. The displays 104 and 106 are contained in frame 102 and may be arranged to provide a two- or three-dimensional image to the user. In the augmented reality configuration, the user is able to concurrently view the external scene with the computer graphics overlaid in the presentation. Because the display device 510 is also coupled to the I/O bridge 507, the processor system 500 is able to update the image presented on display 104 and 106 based on the data captured by the cameras 520

For instance, based on a detected gesture, the processor system 500 may alter the image displayed to the user.

Audio output modules 514 and audio input modules 522 may enable three-dimensional aural environments and voice control capabilities respectively. Three-dimensional aural environments provide non-visual cues and realism to virtual environments. An advantage provided by this technology is signaling details about the virtual environment that are outside the current field of view. Left audio output 222 and right audio output 224 provide the processed audio data to the wearer such that the sounds contain the necessary cues such as (but not limited to) delays, phase shifts, attenuation, etc. to convey the sense of spatial localization. This can enhance the quality of video game play as well as provide audible cues when the HMII 100 may be employed in augmented reality situation with, for example, low light levels. Also high-end audio processing of the left audio input 232 and right audio input 234 could enable voice recognition not just of the wearer but other speakers as well. Voice recognition commands could augment gesture recognition by activating modality switching, adjusting sensitivity, enabling the user to add a new gesture, etc.

FIG. 2 also shows that frame 102 contains motion tracking module 226 which communicates position, orientation, and motion tracking data to processor system 500. In one embodiment, the motion tracking module 226 incorporates sensors to detect position, orientation, and motion of frame 102. Frame 102 also contains interface points for external devices (not shown) to support haptic feedback devices, light sources, directional microphones, etc. The list of these devices is not meant to be exhaustive or limiting to just these examples.

A wireless module 228 is also contained within frame 102 and communicating to the processor system 500. Wireless module 228 is configured to provide wireless communication between the processor system and remote systems. Wireless module 228 is dynamically configurable to support standard wireless protocols. Wireless module 228 communicates with processor system 500 through network adapter 518.

### Head-Mounted Integrated Interface Process Flow

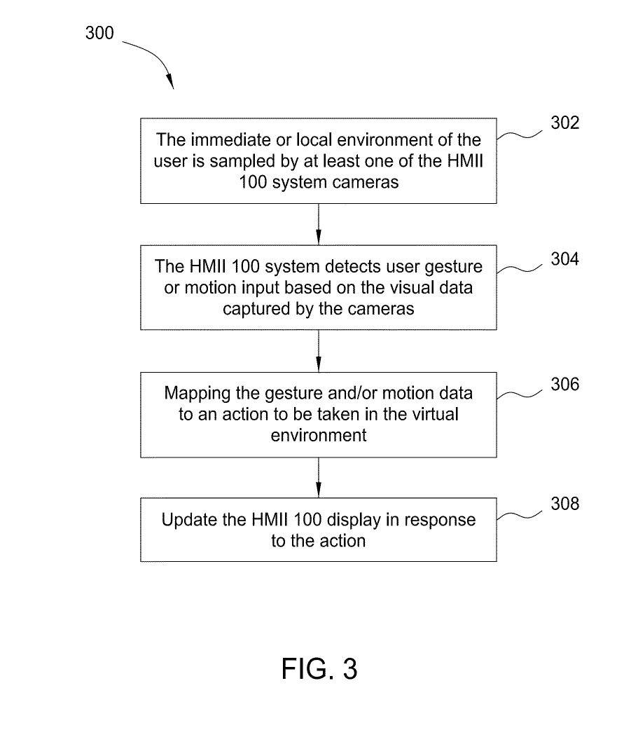

FIG. 3 is a flow diagram of detecting user gestures for changing the virtual environment presented to the user, according to one embodiment of the present invention. Although the steps are described in conjunction with FIGS. 1-6, persons skilled in the art will understand that any system configured to perform the steps, in any order, falls within the scope of the present invention.

As shown, a method 300 begins at step 302, where the immediate or local environment of the user is sampled by at least one of the cameras in the HMII 100. The visual data captured by the one or more of the cameras may include a user gesture.

At step 304, the HMII 100 system detects a predefined user gesture or motion input based on the visual data captured by the cameras. A gesture can be as simple as pointing with an index finger or as complex as a sequence of motions such as American Sign Language, Gestures can also include gross limb movement or tracked eye movements. In one embodiment, accurate gesture interpretation may depend on the visual context in which the gesture is made, e.g. game environment gesture may indicate a direction of movement while the same gesture in an augmented reality application might request data output.

In one embodiment, to identify the gesture from the background image, the HMII 100 performs a technique for extracting the gesture data from the sampled real environment data. For instance, the HMII 100 may filter the scene to determine the gesture context, e.g. objects, motion paths, graphic displays, etc. that correspond to the situation in which the gestures were recorded. Filtering can, for example, remove jitter or other motion artifacts, reduce noise, and preprocess image data to highlight edges, regions-of-interest, etc. For example, in a gaming application if the HMII 100 is unable, because of low contrast, to distinguish between a user's hand and the background scene, user gestures may go undetected and frustrate the user. Contrast enhancement filters coupled with edge detection can obviate some of these problems.

At step 306, the gesture input module of the HMII 100 interprets the gesture and/or motion data detected at step 304. In one example, the HMII 100 includes a datastore or table for mapping the identified gesture to an action in the virtual environment being display to the user. For example, the certain gesture may map to a moving a virtual paintbrush. As the user moves her hand, the paintbrush in the virtual environment displayed by the HMII 100 follows the user's movements. In another embodiment, a single gesture may map to different actions. As discussed above, the HMII 100 may use a context of the virtual environment to determine which action maps to the particular gesture.

At step 308, HMII 100 updates the visual display and audio output based on the action identified in step 306 by changing the virtual environment and/or generating a sound. For example, in response to a user swinging her arm (i.e., the user gesture), the HMII 100 may manipulate an avatar in the virtual environment to strike an opponent or object in the game environment (i.e., the virtual action). Sound and visual cues would accompany the action thus providing richer feedback to the user and enhancing the game experience.

### HMII Operation with External Systems

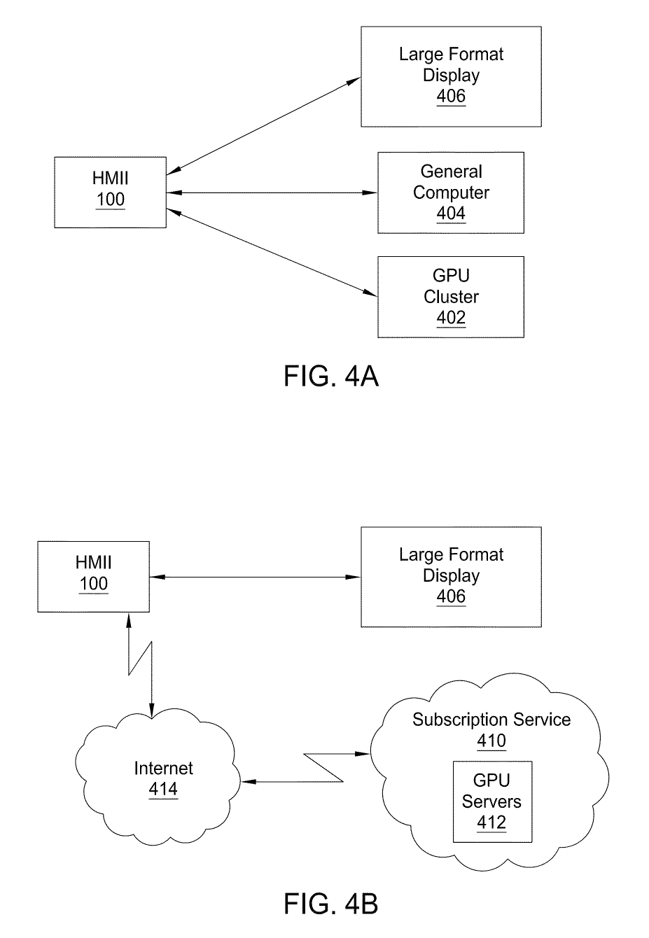

FIG. 4A illustrates one configuration for use of the HMII 100 with local resources, according to one embodiment of the present invention. Local resources, for example, can be those systems available over a secure data transfer channel (e.g., a direct communication link between the HMII 100 and the local resource) and/or network (e.g., a LAN). HMII 100 can wirelessly interface to external general purpose computer 404 and/or a Graphics Processing Unit (GPU) cluster 402 to augment the computational resources for HMII 100. The processor system described below further enables data compression of the visual data both to and from the HMII 100.

By integrating with external computer systems 402 and 404, the HMII 100 is able to direct more of the “on-board” processing resources to the task of interfacing with complex virtual environments such as, but not limited to, integrated circuit analysis, computational fluid dynamics, gaming applications, molecular mechanics, teleoperation controls. Stated differently, the HMII 100 can use its wireless connection to the general purpose computer 404 or CPU cluster 402 to leverage the graphic processors on these components in order to, e.g., conserve battery power or perform more complex tasks.

Moreover, advances in display technology and video signal compression technology have enabled high quality video delivered wirelessly to large format displays such as large format wall mounted video systems. The HMII 100 is capable of wirelessly driving a large format display 406 similar to large format wall mounted systems. In addition to the capability to display wireless transmissions, HMII 100 has sufficient resolution and refresh rates to synchronize with the HMII 100 displays and the external display device such as the large format display 406, concurrently. Thus, whatever is being displayed to the user via the display in the HMII may also be displayed on the external display 406. As the HMII 100 uses, for example, gestures to alter the virtual environment, these alterations are also presented on the large format display 406.

FIG. 4B illustrates a configuration for use of the HMII 100 with networked resources, according to one embodiment of the present invention. In this embodiment, the HMII 100 may use standard network protocols (e.g., TCP/IP) for communicating with the networked resources. Thus, the HMII 100 may be fully compatible with resources available over the Internet 414 including systems or software as a service (SaaS) 410, subscription services for servers, and Internet II. The HMII 100 can connect via the Internet 414 with subscription service 410 that provides resources such as, but not limited to, GPU servers 412. As described above, the GPU servers 412 may augment the computational resources for HMII 100. By leveraging the graphics processing resources in the servers 412 to aid in generating the images displayed to the user, the HMII 100 may be able to perform more complex task than otherwise would be possible.

In one embodiment, the subscription service 410 may be a cloud service which further enhances the portability of the HMII 100. So long as the user has an Internet connection, the HMII 100 can access the service 410 and take advantage of the GPU servers 412 included therein. Because multiple user subscribe to the service 410, this may also defray the cost of upgrading the GPU servers 410 as new hardware/software is released.

### Representative Processor Overview

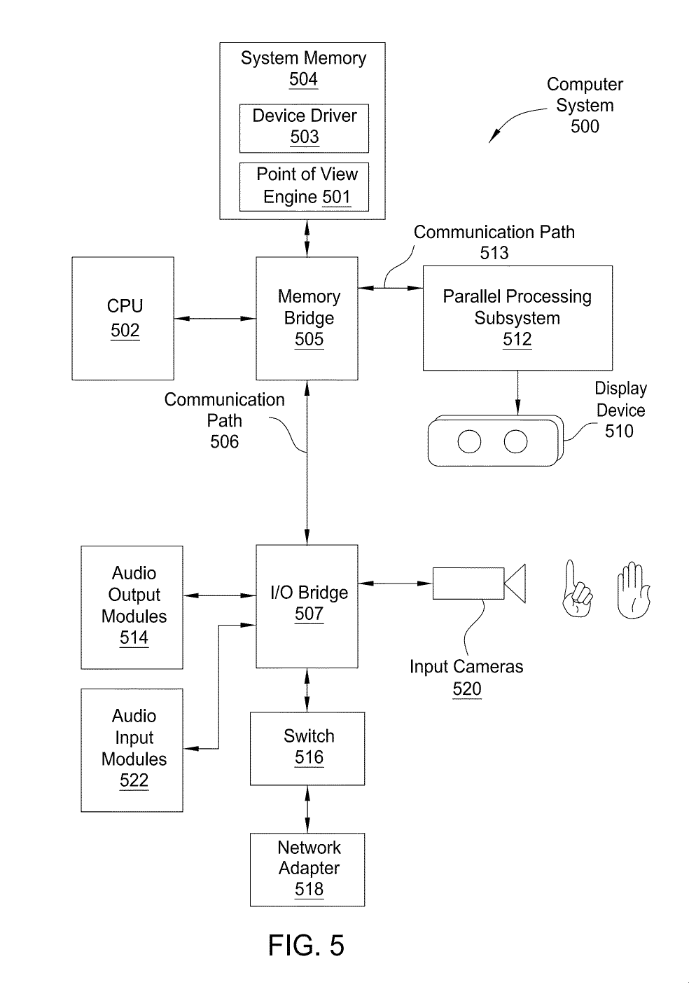

FIG. 5 is a block diagram illustrating a processor system 500 configured to implement one or more aspects of the present invention. Any processor known or to be developed that provides the minimal necessary capabilities such as (and without limitation) compute capacity, power consumption, and speed may be used in implementing one or more aspects of the present invention. As shown, processor system 500 includes, without limitation, a central processing unit (CPU) 502 and a system memory 504 coupled to a parallel processing subsystem 512 via a memory bridge 505 and a communication path 513. Memory bridge 505 is further coupled to an I/O (input/output) bridge 507 via a communication path 506, and I/O bridge 507 is, in turn, coupled to a switch 516.

In operation, I/O bridge 507 is configured to receive information (e.g., user input information) from input cameras 520, gesture input devices, and/or equivalent components, and forward the input information to CPU 502 for processing via communication path 506 and memory bridge 505. Switch 516 is configured to provide connections between I/O bridge 507 and other components of the computer system 500, such as a network adapter 518. As also shown, I/O bridge 507 is coupled to an audio output modules 514 that may be configured to output audio signals synchronized with the displays. In one embodiment audio output modules 514 is configured to implement a 3D auditory environment. Finally, although not explicitly shown, other components, such as universal serial bus or other port connections, compact disc drives, digital versatile disc drives, film recording devices, and the like, may be connected to I/O bridge 507 as well.

In various embodiments, memory bridge 505 may be a Northbridge chip, and I/O bridge 507 may be a Southbrige chip. In addition, communication paths 506 and 513, as well as other communication paths within computer system 500, may be implemented using any technically suitable protocols, including, without limitation, AGP (Accelerated Graphics Port), HyperTransport, or any other bus or point-to-point communication protocol known in the art.

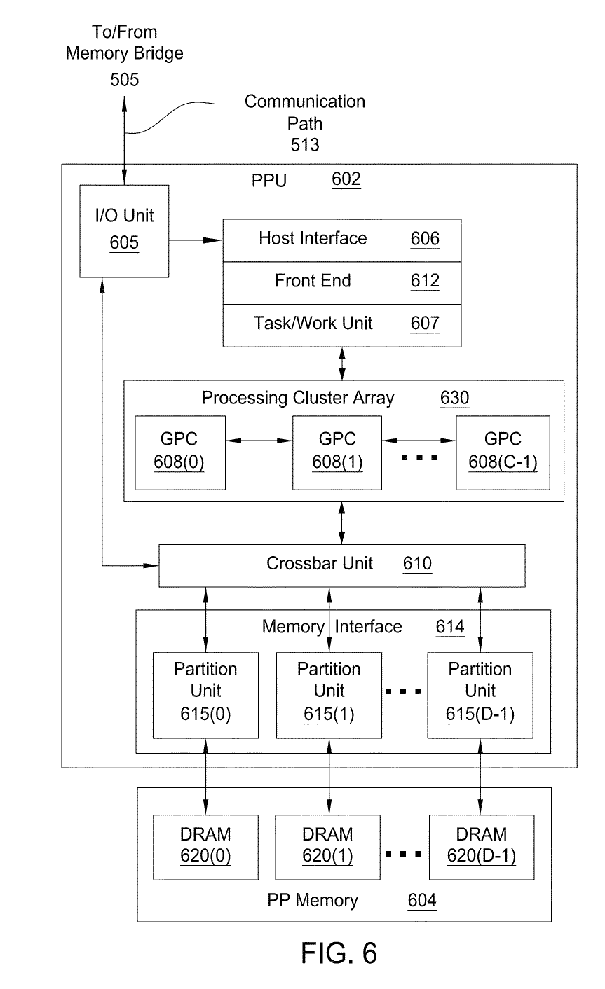

In some embodiments, parallel processing subsystem 512 comprises a graphics subsystem that delivers pixels to a display device 510 that may be any conventional cathode ray tube, liquid crystal display, light-emitting diode display, or the like. In such embodiments, the parallel processing subsystem 512 incorporates circuitry optimized for graphics and video processing, including, for example, video output circuitry. As described in greater detail below in FIG. 6, such circuitry may be incorporated across one or more parallel processing units (PPUs) included within parallel processing subsystem 512. In other embodiments, the parallel processing subsystem 512 incorporates circuitry optimized for general purpose and/or compute processing. Again, such circuitry may be incorporated across one or more PPUs included within parallel processing subsystem 512 that are configured to perform such general purpose and/or compute operations. In yet other embodiments, the one or more PPUs included within parallel processing subsystem 512 may be configured to perform graphics processing, general purpose processing, and compute processing operations. System memory 504 includes at least one device driver 503 configured to manage the processing operations of the one or more PPUs within parallel processing subsystem 512. System memory 504 also includes a point of view engine 501 configured to receive information from input cameras 520, motion tracker, or other type of sensor. The point of view engine 501 then computes field of view information, such as a field of view vector, a two-dimensional transform, a scaling factor, or a motion vector. The point of view information may then be forwarded to the display device 510.

In various embodiments, parallel processing subsystem 512 may be integrated with one or more of the other elements of FIG. 5 to form a single system. For example, parallel processing subsystem 512 may be integrated with the, memory bridge 505, I/O bridge 507, and/or other connection circuitry on a single chip to form a system on chip (SoC).

It will be appreciated that the system shown herein is illustrative and that variations and modifications are possible. The connection topology, including the number and arrangement of bridges, the number of CPUs 502, and the number of parallel processing subsystems 512, may be modified as desired. For example, in some embodiments, system memory 504 could be connected to CPU 502 directly rather than through memory bridge 505, and other devices would communicate with system memory 504 via CPU 502. In other alternative topologies, parallel processing subsystem 512 may be connected to I/O bridge 507 or directly to CPU 502, rather than to memory bridge 505. In still other embodiments, I/O bridge 507 and memory bridge 505 may be integrated into a single chip instead of existing as one or more discrete devices. Lastly, in certain embodiments, one or more components shown in FIG. 5 may not be present. For example, switch 516 could be eliminated and network adapter 518 would connect directly to I/O bridge 507.

FIG. 6 is a block diagram of a parallel processing unit (PPU) 602 included in the parallel processing subsystem 512 of FIG. 5, according to one embodiment of the present invention. Although FIG. 6 depicts one PPU 602 having a particular architecture, as indicated above, parallel processing subsystem 512 may include any number of PPUs 602 having the same or different architecture. As shown, PPU 602 is coupled to a local parallel processing (PP) memory 604. PPU 602 and PP memory 604 may be implemented using one or more integrated circuit devices, such as programmable processors, application specific integrated circuits (ASICs), or memory devices, or in any other technically feasible fashion.

In some embodiments, PPU 602 comprises a graphics processing unit (CPU) that may be configured to implement a graphics rendering pipeline to perform various operations related to generating pixel data based on graphics data supplied by CPU 502 and/or system memory 504. When processing graphics data, PP memory 604 can be used as graphics memory that stores one or more conventional frame buffers and, if needed, one or more other render targets as well. Among other things, PP memory 604 may be used to store and update pixel data and deliver final pixel data or display frames to display device 510 for display. In some embodiments, PPU 602 also may be configured for general-purpose processing and compute operations.

In operation, CPU 502 is the master processor of computer system 500, controlling and coordinating operations of other system components. In particular, CPU 502 issues commands that control the operation of PPU 602. In some embodiments, CPU 502 writes a stream of commands for PPU 602 to a data structure (not explicitly shown in either FIG. 5 or FIG. 6) that may be located in system memory 504, PP memory 604, or another storage location accessible to both CPU 502 and PPU 602. A pointer to the data structure is written to a pushbuffer to initiate processing of the stream of commands in the data structure. The PPU 602 reads command streams from the pushbuffer and then executes commands asynchronously relative to the operation of CPU 502. In embodiments where multiple pushbuffers are generated, execution priorities may be specified for each pushbuffer by an application program via device driver 503 to control scheduling of the different pushbuffers.

As also shown, PPU 602 includes an input/output (I/O) unit 605 that communicates with the rest of computer system 500 via the communication path 513 and memory bridge 505. I/O unit 605 generates packets (or other signals) for transmission on communication path 513 and also receives all incoming packets (or other signals) from communication path 513, directing the incoming packets to appropriate components of PPU 602. For example, commands related to processing tasks may be directed to a host interface 606, while commands related to memory operations (e.g., reading from or writing to PP memory 604) may be directed to a crossbar unit 610. Host interface 606 reads each pushbuffer and transmits the command stream stored in the pushbuffer to a front end 612.

As mentioned above in conjunction with FIG. 5, the connection of PPU 602 to the rest of computer system 500 may be varied. In some embodiments, parallel processing subsystem 512, which includes at least one PPU 602, is implemented as an add-in card that can be inserted into an expansion slot of computer system 500. In other embodiments, PPU 602 can be integrated on a single chip with a bus bridge, such as memory bridge 505 or I/O bridge 507. Again, in still other embodiments, some or all of the elements of PPU 602 may be included along with CPU 502 in a single integrated circuit or system of chip (SoC).

In operation, front end 612 transmits processing tasks received from host interface 606 to a work distribution unit (not shown) within task/work unit 607. The work distribution unit receives pointers to processing tasks that are encoded as task metadata (TMD) and stored in memory. The pointers to TMDs are included in a command stream that is stored as a pushbuffer and received by the front end unit 612 from the host interface 606. Processing tasks that may be encoded as TMDs include indices associated with the data to be processed as well as state parameters and commands that define how the data is to be processed. For example, the state parameters and commands could define the program to be executed on the data. The task/work unit 607 receives tasks from the front end 612 and ensures that GPCs 608 are configured to a valid state before the processing task specified by each one of the TMDs is initiated. A priority may be specified for each TMD that is used to schedule the execution of the processing task. Processing tasks also may be received from the processing cluster array 630. Optionally, the TMD may include a parameter that controls whether the TMD is added to the head or the tail of a list of processing tasks (or to a list of pointers to the processing tasks), thereby providing another level of control over execution priority.

PPU 602 advantageously implements a highly parallel processing architecture based on a processing cluster array 630 that includes a set of C general processing clusters (GPCs) 608, where C≧1. Each GPC 608 is capable of executing a large number (e.g., hundreds or thousands) of threads concurrently, where each thread is an instance of a program. In various applications, different GPCs 608 may be allocated for processing different types of programs or for performing different types of computations. The allocation of GPCs 608 may vary depending on the workload arising for each type of program or computation.

Memory interface 614 includes a set of D of partition units 615, where D≧1. Each partition unit 615 is coupled to one or more dynamic random access memories (DRAMs) 620 residing within PPM memory 604. In one embodiment, the number of partition units 615 equals the number of DRAMs 620, and each partition unit 615 is coupled to a different DRAM 620. In other embodiments, the number of partition units 615 may be different than the number of DRAMs 620. Persons of ordinary skill in the art will appreciate that a DRAM 620 may be replaced with any other technically suitable storage device. In operation, various render targets, such as texture maps and frame buffers, may be stored across DRAMs 620, allowing partition units 615 to write portions of each render target in parallel to efficiently use the available bandwidth of PP memory 604.

A given GPCs 608 may process data to be written to any of the DRAMs 620 within PP memory 604. Crossbar unit 610 is configured to route the output of each GPC 608 to the input of any partition unit 615 or to any other GPC 608 for further processing. GPCs 608 communicate with memory interface 614 via crossbar unit 610 to read from or write to various DRAMs 620. In one embodiment, crossbar unit 610 has a connection to I/O unit 605, in addition to a connection to PP memory 604 via memory interface 614, thereby enabling the processing cores within the different GPCs 608 to communicate with system memory 504 or other memory not local to PPU 602. In the embodiment of FIG. 6, crossbar unit 610 is directly connected with I/O unit 605. In various embodiments, crossbar unit 610 may use virtual channels to separate traffic streams between the GPCs 608 and partition units 615.

Again, GPCs 608 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 602 is configured to transfer data from system memory 504 and/or PP memory 604 to one or more on-chip memory units, process the data, and write result data back to system memory 504 and/or PP memory 604. The result data may then be accessed by other system components, including CPU 502, another PPU 602 within parallel processing subsystem 512, or another parallel processing subsystem 512 within computer system 500.

As noted above, any number of PPUs 602 may be included in a parallel processing subsystem 512. For example, multiple PPUs 602 may be provided on a single add-in card, or multiple add-in cards may be connected to communication path 513, or one or more of PPUs 602 may be integrated into a bridge chip. PPUs 602 in a multi-PPU system may be identical to or different from one another. For example, different PPUs 602 might have different numbers of processing cores and/or different amounts of PP memory 604. In implementations where multiple PPUs 602 are present, those PPUs may be operated in parallel to process data at a higher throughput than is possible with a single PPU 602. Systems incorporating one or more PPUs 602 may be implemented in a variety of configurations and form factors, including, without limitation, desktops, laptops, handheld personal computers or other handheld devices, servers, workstations, game consoles, embedded systems, and the like.

In sum, the HMII includes a wearable head-mounted display unit supporting two compact high resolution screens for outputting a right eye and left eye image in support of the stereoscopic viewing, wireless communication circuits, three-dimensional positioning and motion sensors, a high-end processor capable of: independent software processing, processing streamed output from a remote server, a graphics processing unit capable of also functioning as a general parallel processing system, multiple imaging input, cameras positioned to track hand gestures, and high definition audio output. The HMII cameras are oriented to record the surrounding environment for integrated display by the HMII. One embodiment of the HMII would incorporate audio channels supporting a three-dimensional auditory environment. The HMII would further be capable of linking with a GPU server, subscription computational service, e.g. “cloud” servers, or other networked computational and/or graphics resources, and be capable of linking and streaming to a remote display such as a large screen monitor.

One advantage of the HMII disclosed herein is that a user has a functionally complete wireless interface to a computer system. Furthermore, the gesture recognition capability obviates the requirement for additional hardware components such as data gloves, wands, or keypads. This permits unrestricted movement by the user/wearer as well as a full featured portable computer or gaming platform. In some embodiments, the HMII can be configured to link with remote systems and thereby take advantage of scalable resources or resource sharing. In other embodiments the may be configured to enhance or augment the perception the wearer's local environment as an aid in training, information presentation, or situational awareness.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

The claimed invention is:

1. A user-wearable apparatus comprising:
at least one display disposed in front of an eye of a user and configured to present a computer-generated image to the user;
at least two cameras, each camera being associated with a respective field-of-view, wherein the respective fields-of-view overlap to allow a gesture of the user to be captured;
a gesture input module coupled to the at least two cameras and configured to receive visual data from the at least two cameras and identify the user gesture within the visual data, wherein the identified gesture is used to affect the computer-generated image presented to the user.

2. The apparatus of claim 1, wherein the gesture input module is configured to map the identified gesture to a predetermined action in a virtual environment, wherein the predetermined action is used to generate the computer-generated image presented to the user.

3. The apparatus of claim 1, further comprising a power module configured to power the apparatus and permit mobile operation of the apparatus.

4. The apparatus of claim 1, wherein the at least two cameras are disposed on the apparatus such that, when the apparatus is worn by the user, the respective fields-of-view capture user gestures below a bottom surface of the apparatus.

5. The apparatus of claim 1, wherein the gesture input module is configured to distinguish the user gesture using at least sub-millimeter movement resolution.

6. The apparatus of claim 1, wherein the at least one display comprises a first screen and a second screen, each screen being disposed in front of a respective eye of the user, and wherein a first image displayed on the first screen and a second image displayed on the second screen are perceived by the user as the computer-generated image.

7. The apparatus of claim 1 further comprising a wireless network adapter configured to communicate with a remote computing device to create the computer-generated image based on the identified gesture.

8. The apparatus of claim 7, wherein the wireless network adapter is further configured to communicate with a remote display in order to display at least a portion of the computer-generated image on the remote display.

9. The apparatus of claim 1, further comprising logic configured to switch the apparatus into a mode of operation wherein, without external communication with any remote device;
the gesture input module is configured to receive visual data from the at least two cameras and identify the gesture within the visual data, and
the identified gesture is used to affect the computer-generated image presented to the user.

10. A method for providing an image to a user, the method comprising:
capturing visual data using at least two cameras disposed on a user-wearable apparatus, each camera being associated with a respective field-of-view, wherein the respective fields-of-view overlap to allow a gesture of the user to be captured;
indentifying, using the user-wearable apparatus, the user gesture within the visual data; and
generating the image displayed to the user based on the identified gesture, wherein the image is presented on a display integrated into the user-wearable apparatus.

11. The method of claim 10, further comprises:
mapping the identified gesture to a predetermined action in a virtual environment, wherein the predetermined action is used to generate the image presented to the user.

12. The method of claim 10, further comprising a power module configured to power the apparatus and permit mobile operation of the apparatus.

13. The method of claim 10, wherein the at least two cameras are disposed on the apparatus such that, when the apparatus is worn by the user, the respective fields-of-view capture user gestures below a bottom surface of the apparatus.

14. The method of claim 10, wherein the user gesture is identified using at least sub-millimeter movement resolution.

15. The method of claim 10, further comprising:
displaying a first image on a first screen of the display; and
displaying a second image on a second screen of the display, wherein the first and second screens are disposed in front of a respective eye of the user, and wherein the first image and the second image are perceived by the user as a combined image.

16. The method of claim 10, further comprising wirelessly communicating with a remote computing system that provides additional graphics processing for generating the image displayed to the user based on the identified gesture.

17. A system comprising:
an apparatus configured to be wearable on a head of a user; the apparatus comprising:
at least one display disposed in front of an eye of the user and configured to present a computer-generated image to the user,
a wireless network adapter; and
a remote computing system configured to communicate with the wireless network adapter, the remote computing system comprising graphic processing unit (GPU) cluster configured to generate at least a portion of the computer-generated image presented on the display of the apparatus.

18. The system of claim 17 wherein the remote computing system is associated with a subscription service that provides access to the GPU clusters for a fee.

19. The system of claim 17, wherein the remote computing system is a cloud-based resource.

20. The system of claim 17, further comprising a wide-access network configured to provide connectivity between the wireless adapter and the remote computing resource, wherein the remote computing system is configured to use data compression when communicating with the wireless network adapter.
